(19) United States
(12) Patent Application Publication
(10) Pub. No.: US 2008/0149670 A1
(43) Pub. Date: Jun. 26, 2008

(54) Warm Food Product Distributor

(76) Inventor: Marco Bianchi, Lido di Camaiore (IT)

Correspondence Address: DENNISON, SCHULTZ & MACDONALD, 1727 KING STREET, SUITE 105, ALEXANDRIA, VA, 22314, US

(21) Appl. No.: 11/720,437

(22) PCT Filed: Dec. 6, 2005
(86) PCT No.: PCT/EP2005/013059

§ 371 Date: Nov. 29, 2007

(30) Foreign Application Priority Data
Dec. 7, 2004 (IT) PI2004A000091

(51) Int. Cl. B67D 5/62

(52) U.S. Cl. 222/146.2

(57) ABSTRACT

The present invention relates to an apparatus capable of supplying a portion of warm food product, consisting at least of one food component, for example selected among typical components of the dressing of a pizza, and used for filling an edible container, for example a wafer, creating a ready-to-eat single-dose warm food product. The apparatus provides a heating chamber (20) comprising a recess having an inner heated surface (82), in which a piston (84) slides sweeping the surface (82) and pushing towards an outlet (83) at least one food component (33) heated in said heating chamber (20) and coming from a magazine (30). The magazine (30) may be refrigerated (32), and a liquid food component (40) may be added. The heating chamber (20) is heated by an electrical resistance (81). The apparatus, furthermore, comprises a system (50) for applying a dressing on the upper surface of the product and a carousel (60) for positioning automatically an edible container (71) in different operative stations.

### FIELD OF THE INVENTION

The present invention relates to the food field and, in particular, it relates to a device for filling a portable container with a dose of warm food product ready to be eaten.

### DESCRIPTION OF THE PRIOR ART

Various types are known of food products that can be eaten holding them in hands and that have a stiff edible structure, for example a wafer, and filled with food.

Mainly two categories of product of this kind are known, i.e. warm and cold food. In the first category, for example, ice creams and in the second, for example, pizza cones are known.

With reference to the category of warm food and, in particular to pizza cones, as described in U.S. Pat. No. 4,463,021, the use is known of an edible cone having size and features such that it can be kept easily in hands while it is eaten. The cone may comprise a releasable wrapper that wraps the lower part to protect the user's hands from heat. The filling of the pizza cones may comprise a conventional pizza dressing such as mozzarella or other cheese, tomato or other sauces, delicatessen, olives and the like. Other edible cones that can be filled with warm food are described in EP 0313791.

According to the prior art, a process for filling and preparing the pizza cones comprises the steps of prearranging the cone with the opening up, filling it manually with the desired dressing previously prepared, and once filled heating it in oven up to melting and cooking of the dressing.

Such process provides that the pizza cones is ready-to-eat product, prepared when requested by a customer in a public place. In particular, after receiving a request the operator has to prepare the dressing, to fill the cone with such dressing, and to arrange the filled cone in an oven. The oven used, sometimes, is semiautomatic and is associated to a carousel with cone-holders moving on a loop that crosses the oven and brings the cone, just heated, out of the oven accessible to the operator. Such a method is described in WO2005/039296.

The known method just described has the limitation of a not negligible waiting time, since the operations of preparing the dressing and the filling require several minutes, and the next cooking step in the oven requires also several minutes, with an overall waiting time often too long in case of crowded places, negatively affecting the client satisfaction owing to people queing.

Another limitation to the known method is given by the fact that they are not completely automatic, and require the presence of an operator for the steps of preparing and filling the cones.

The presence, furthermore, of wet and cold cheese in the cone for minutes before that it melts in the oven affects or reduces the fragility of the wafer of the cone, causing the cone to be soggy and less pleasant or requiring more compact cones.

### SUMMARY OF THE INVENTION

It is a feature of the present invention to provide a device for supplying a dose of a food product into an edible container that requires minimum waiting time for the customers less than required by the devices according to the prior art.

Another feature of the present invention is to provide such a device that is capable to carry out all the above described operations automatically according to the customers tastes and preferences.

A further feature of the invention is to provide a method for supplying a dose of a warm food product into an edible container that is substantially quicker than the known method and that is capable to be automated.

It is, furthermore, a feature of the present invention to provide such a device for use with an edible container of whichever shape.

These and other objects are achieved by an apparatus for supplying a dose of warm food product, characterised in that it comprises means for receiving at least one component of said dose, heating it and putting it, once heated, into a stiff edible container, creating ready-to-eat combination of said at least one warm food component and of said edible container.

Preferably, said means for receiving at least one component of said dose, heating it and putting it, once heated, into an edible container, comprises:
an inlet for at least one component of said food product;
at least one heating chamber with means for heating said or each component put in through said inlet;
means for moving towards an outlet said or each component after heating in said chamber and for creating a dose of a warm food product directly in said edible container.

Preferably, said means for heating said at least one component provides a preheated surface with which said component comes into contact.

In a preferred exemplary embodiment, said preheated surface is a base surface of a shaped basin having an outlet for said heated component. In particular, said preheated surface comprises a fixed heating plate.

In this case, said means for moving towards an outlet said or each component after heating comprises a piston coupled to said heating chamber. In particular, said piston sweeps the heated surface on which said component is distributed and pushes it towards said outlet.

Alternatively, said heating chamber comprises an inner rotating horizontal heated disc, suitable for receiving and heating said at least one component, distributed on the upper surface of said disc.

In this case, said means for moving said or each component towards an outlet after heating comprises:
a fixed barrier that is radially arranged in sliding contact with said upper surface of said disc, suitable for stopping and accumulating said at least one food component distributed chopped on said disc, once heated;
a pusher comprising a plate movable along said barrier, having an edge sliding on said barrier and an edge sliding on said disc, said pusher being suitable for pushing radially said at least one component, stopped and accumulated on said barrier, towards an outlet.

In particular, said basin, said plate or said disc are removable for cleaning operations.

Advantageously, for enhancing heat exchange between said surface and said component one of the following steps is provided:
shredding said component and distributing it on all said surface;
dragging said component on said surface;
rolling said component on said surface.

This way, the heat exchange is maximum between the component and the surface minimizing the time for preparing said dose.

Advantageously, said inlet comprises a container arranged in a refrigerating chamber, suitable for keeping at a preservation temperature said or each component before bringing it into said heating chamber.

In a preferred exemplary embodiment, said inlet is suitable for containing an edible component in blocks. In this case, means are provided for shredding said or each edible component in blocks before bringing it into said heating chamber.

In a possible exemplary embodiment, means are provided for bringing about a relative movement between said shredding means and said heating chamber, suitable for distributing said component regularly on the surface of said chamber.

Alternatively, said container is a hopper comprising a sensor for measuring the filling level thereof.

In a possible exemplary embodiment, said heating chamber comprises means for mixing said or each component. Preferably, said means for mixing comprises a driven helical surface arranged in said heating chamber, said helical surface displacing progressively said or each component towards an outlet.

In particular, said helical surface arranged in said heating chamber has a vertical axis and high angle of inclination of the helical surface, in order to have a high slope to assist the sliding of said or each component by gravity towards an outlet. Alternatively, said helical surface has an inclined axis.

In a further alternative exemplary embodiment, said at least one food component is kept in a single-dose cartridge or in a cartridge with a limited number of doses. This way a good level of hygiene and freshness of the product is ensured since the cartridge is open only just before dispensation.

Advantageously, said cartridge is suitable for being put into said heating chamber for being then opened operatively to provide said at least one warm food component.

Advantageously, said cartridge has a portion that can be opened automatically.

In particular, means are provided for opening automatically said portion of said cartridge selected from the group comprised of:
a recess containing operatively said cartridge and a piston suitable for compressing said cartridge by means of relative movement up to smashing said portion;
a recess containing operatively said cartridge and a cutting element capable of penetrating into said portion by means of relative movement.

In particular, said recess is said heating chamber.

Advantageously, said cartridge is obtained with a stiff or flexible material and has a shape selected from the group comprised of:
a cylinder;
a prism with two bases having size much larger than the height;
a closed tray with a surface that can be perforated;
a bag with substantially plane shape.

In a possible exemplary embodiment, said heating chamber has a bottom with an opening and said means for moving towards an outlet provide means for having a overpression in order to push said or each component towards said opening.

Preferably, said heating chamber comprises a dosing outled device with automatic valve or timer or electronic operation.

Advantageously, said heating chamber comprises means for feeding at least one liquid substance in said chamber, said liquid substance assisting and completing the homogenization of said or each component.

In particular, said at least one liquid substance is selected from the group comprised of: milk, water or oil solutions of flavouring substances, sauces and combination thereof.

Advantageously, said apparatus for supplying a dose of a warm food product comprises means for adding at least one food dressing component on top of said combination of said warm food product and of said edible container.

In particular, said at least one food component is selected from the group comprised of:
cheese;
meat or delicatessen;
fresh or preserved vegetables;
pickled or in oil food;
fish.

In particular, said stiff edible container is a baked product with concave thin-walled shape.

For example, it can be of biscuit, a wafer, bread, pasta, etc.

Said container, preferably, has a shape selected from the group comprised of:
a shell representing a geometrical figure, such as a spherical, cylindrical, conic, cubic shell etc.;
a shell representing a fruit or a vegetal;
a shell that represents an animal, a character, a flower, etc.;
a shell that represents a common object.

In a possible exemplary embodiment of the invention, means are provided for carrying said edible container under said means for moving, with at least one support element for said edible container, suitable for picking up and positioning said edible container at least at one operative station.

In particular, said means for carrying comprises a carousel support having a plurality of movable gripping elements selectively through any of the following stations:
container pick up;
container heating;
container filling;
adding at least one food dressing component;
product delivery.

In particular, said movable gripping elements comprises a slot portion with shape capable of receiving and supporting any types of said edible container. This way said slot portion is suitable for a multipurpose use and said apparatus can be automatic.

In an exemplary embodiment of the invention, said apparatus is an automatic apparatus contained completely in a stiff casing, creating a vending machine, suitable for delivering said combination of said warm food product and of said edible container automatically according to the combination selected by a customer.

In particular, said automatic apparatus comprises:
a refrigerated feeder for a plurality of cartridges suitable for being selectively picked up;
a heating chamber for a cartridge picked up from said refrigerated feeder;
a feeder for a plurality of edible containers suitable for being selectively picked up;
means for opening said cartridge and squeezing said warm food component from said cartridge into an edible container previously picked up.

### BRIEF DESCRIPTION OF THE DRAWINGS

The invention will be made clearer with the description of some of its exemplary embodiments, exemplifying but not limitative, with reference to the attached drawings wherein:

FIG. 1 shows a block diagram that describes the operation of an apparatus according to the invention and, in particular, the path of the components up to the delivery of the final product;

FIG. 2 shows a block diagram that describes a possible configuration of the present invention, suitable for automatic use;

FIG. 3 shows a diagrammatical view that describes a first exemplary embodiment of the apparatus according to the invention;

FIG. 4 shows a diagrammatical view that describes a second exemplary embodiment of such an apparatus;

FIG. 5 shows diagrammatically an exemplary embodiment of a heating chamber, having an inclined axis;

FIG. 6 shows diagrammatically a further exemplary embodiment of a heating chamber;
figures from 7 to 10 show a cross section of a plurality of edible containers;

FIG. 11 shows a cross section of a multipurpose support element for two different types of edible container;
figures from 12 to 15 show a plurality of supports for edible containers associated to a same support;
figures from 16 to 18 show a diagrammatical view of a preferred exemplary embodiment of the apparatus according to the invention, respectively in three successive steps;

FIGS. 19 and 20 show respectively a front view and top plan view of another preferred exemplary embodiment of an apparatus according to the invention;

FIG. 21 shows a particular exemplary embodiment of a heating chamber comprising a releasable basin and a piston capable of pushing towards an outlet at least one food component, once heated;

FIGS. 22-23 show respectively three exemplary embodiments of a food component in a cartridge having one form suitable for being open in a completely automatic way by a distributor device according to the invention, after having been heated in a heating chamber, for then being transferred into an edible container;

FIGS. 24 and 25 show respectively two exemplary embodiments of a heating chamber for a food component in a cartridge, with means for opening said cartridge.

### DESCRIPTION OF PREFERRED EXEMPLARY EMBODIMENTS

In the following description an apparatus is described capable of supplying a dose of warm food product, consisting at least of one food component, for example selected among typical components of the dressing of a pizza, in particular cheese, delicatessen, pickled or in oil preserved food etc., and using it for filling an edible container, for example a biscuit or a wafer, creating a ready-to-eat single-dose warm food product.

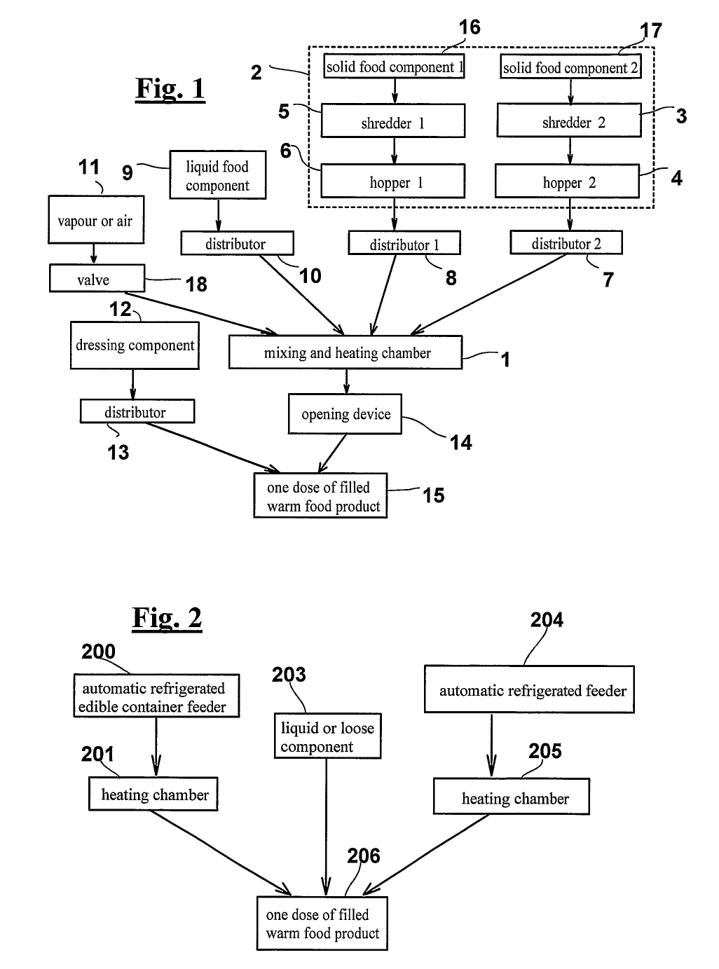

In FIG. 1 a block diagram is shown that describes the operation of such an apparatus and highlights the path of the components that may be solid, chopped, in powder, liquid or vapour, starting from the introduction in the apparatus up to delivery of the ready-to-eat single-dose warm food product.

In particular, the solid food components, for example 16 and 17, are provided at the inlet of the apparatus, then they may be shredded respectively with shredders 5 and 3 and then are moved to a mixing and heating chamber 1, through for example respective hoppers 6 and 4, with relative distributors 7 and 8.

The liquid components, for example indicated with 9, after being distributed in 10 reach also mixing and heating chamber 1.

Some components, for example 16 and 17, may need to be kept at low preserving temperature up to the introduction in heating chamber; in this case components 16 and 17 with the respective shredders 5 and 3, if present, and respective hoppers 6 and 4, can be kept at preservation temperature by a refrigerating chamber 2 that contains them.

Heating chamber 1 has the task of heating the components and, sometimes, mixing them creating the food product that will then be put into an edible container.

Heating chamber 1 may comprise an inlet for vapour or air 11 that has the object to assist mixing the food components during heating and then to assist moving out the components after heating. To this end, the intensity of air flow or vapour is controlled by a valve 18, capable of adjusting gradually the pressure in the heating chamber. This way, it is avoided that the last fraction of product is pushed out at high speed, damaging the edible container or the aspect of the product.

The delivery of the product is, moreover, done by a closing and opening device 14 arranged at the outlet of heating chamber 1, either automatic or manual.

The apparatus can complete to prepare the food product putting on top of the product supplied by the above described device 14, a dressing consisting of components 12, suitably dosed by distributor 13.

In FIG. 2 a block diagram is shown that describes a possible simpler configuration of the present invention, suitable also for an automatic use. This configuration comprises an automatic refrigerated feeder 204 of a food component. It can be for example a shredder of a block of cheese or a feeder of single-dose cartridges containing the food components. This feeder is capable of keeping at a desired temperature such components in order to preserve their quality. When a user selects a product, a component reaches a heating chamber 205 and eventually is brought towards an outlet. In case of a cartridge, heating chamber 205 comprises means for opening automatically the cartridge after heating and squeezing the heated component that is then brought towards an outlet. Also the edible containers are preserved at a temperature in a automatic feeder 200, which can be refrigerated. The edible containers are picked up in turn by automatic feeder 200 according to the requests of the customers. Then, they pass through an heating room 201. At this point the heated edible container is brought to a loading position 206 at which the edible container is filled with the warm food component coming from heating chamber 205. One or more liquid or loose components as a dressing can be added from a reservoir 203.

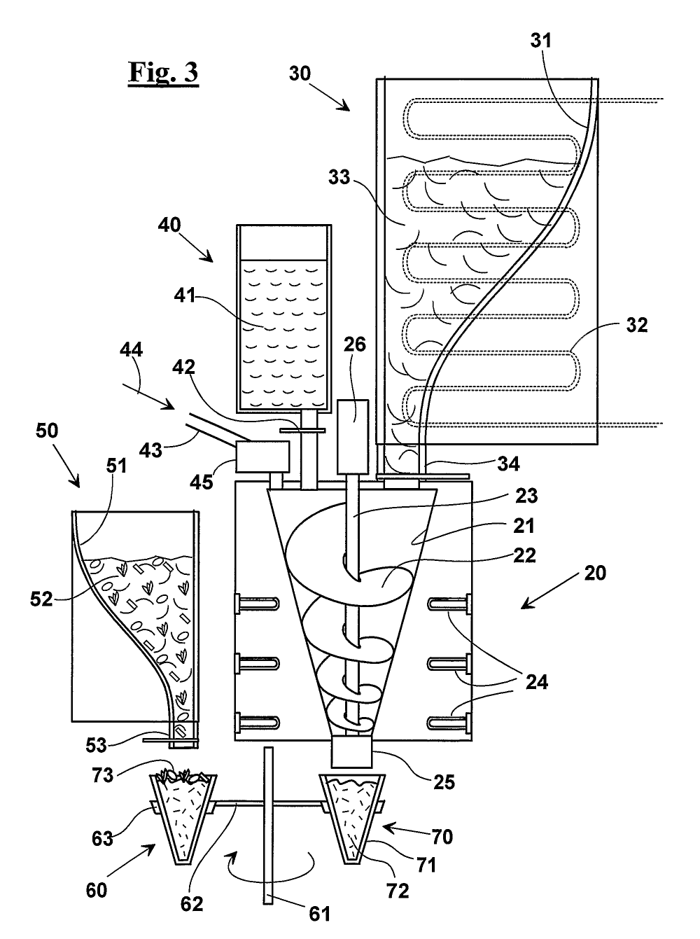

FIG. 3 shows diagrammatically a first exemplary embodiment of the apparatus, according to the invention, capable of supplying a ready-to-eat single-dose warm food product.

The apparatus provides a mixing and heating chamber 20 comprising a heated conical chamber 21, with a heated helical conical surface 22 with a vertical axis, wheeled by a motor 26, for mixing the components. The helical surface 22, is kept at melting temperature for the components and is very smooth.

The solid components are conveyed and then put in the heating chamber, for example by a hopper 31 for components 33, contained in a refrigerated chamber 30, cooled by a circuit 32, and the liquid components 41 are drawn from a reservoir 40. The hopper 30 and the reservoir 40 may comprise level sensors and the introduction of the components is adjusted by distributors 34 and 42.

The mixing and heating chamber 20 comprises, furthermore, an inlet 43 for vapour or air in pressure, indicated by arrow 44, to assist mixing of the components, but especially for clearing the recess 21 and the helical surface 22 from possible residues of components left after delivery of the warm food component. To this end a valve is used 45 for automatic release 44 and for stopping it when the warm food component contained in the heating chamber is about completely out.

Once supplied the warm food component 72 into an edible container, for example a cone 71, the warm food product 70 is completed with a dressing 73 on the upper surface of the product. This dressing 73 is obtained from a system 50 comprising a hopper 51 containing the dressing components 52, through a distributor 53.

Furthermore, the apparatus comprises a carousel 60 for positioning automatically an edible container, for example a cone 71, at the outlet 25, and bringing it in other stations necessary to complete the product. Carousel 60 comprises at least one radial arm 62 having an end support 63 for edible container 71.

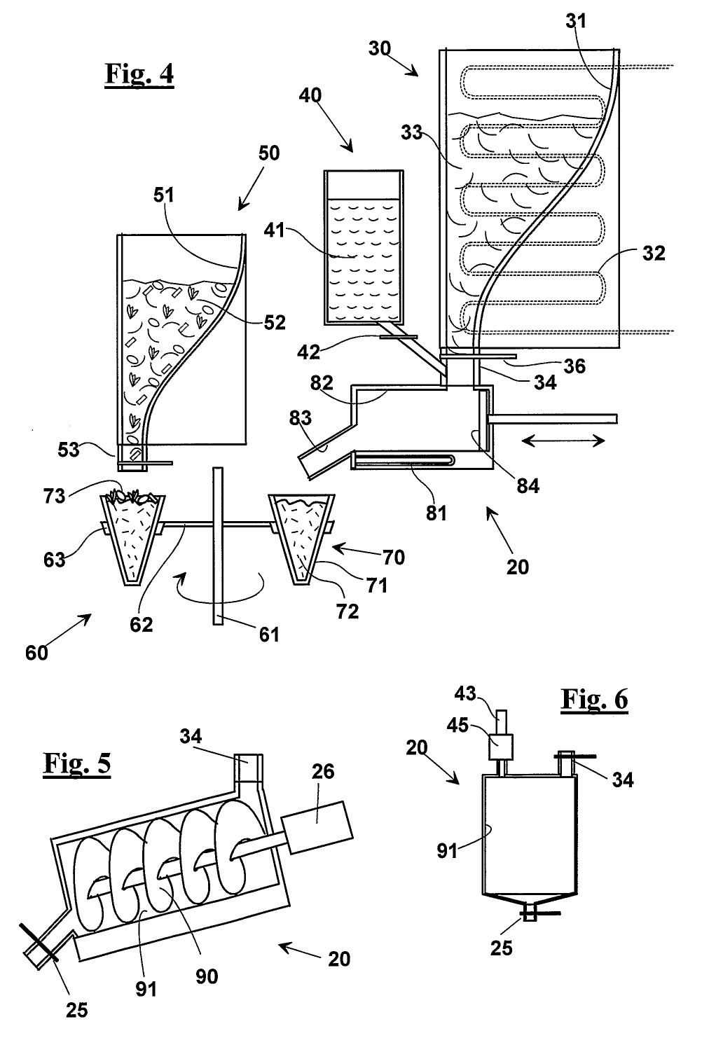

A second exemplary embodiment of the apparatus is diagrammatically shown in FIG. 4. This embodiment is different from that shown in FIG. 3 for the shape of heating chamber 20, which comprises a space 82 crossed by a piston 84. Chamber 20 has at least one inlet, for solid food components 33 and liquid food components 41 through respective distributors 34 and 42, which can be kept at preservation temperature by a circuit 32. When the food components reach space 82 of heating chamber 20, the piston 84 is firstly in the position shown in the figure to let the components to be heated by an electrical resistance 81, and eventually it pushes the heated components through outlet 83.

Alternatively, instead of an electrical resistance, other heating systems can be provided, such as microwave systems, gas-fired heaters, etc.

The apparatus may comprise, furthermore, a system 50 for a dressing and a carousel 60 for positioning automatically an edible container, for example a cone 71, at the outlet 83 of the heating chamber, like that described in FIG. 2.

FIG. 5 shows a different exemplary embodiment of heating chamber 20, having a cylindrical shape 91 and containing an helical cylindrical surface 90 wheeled by a motor 26. The axis of the heating chamber and of the helical surface is slightly inclined with respect to a horizontal plane, to bring the components from an inlet, at a distributor 34, to an outlet at an automatic closing/opening valve 25. The inclination assists by gravity the conveyance on lower wall 91 of the heating chamber through helical surface 90. Heating chamber 20 is heated by means of an electrical resistance not shown in the figure. The figure shows a single inlet, but several inlets may be provided in case of selective introduction of components, such as solid, liquid, powder components.

FIG. 6 shows a further exemplary embodiment of a heating chamber 20. In this embodiment, the components are conveyed from the inlet at distributor 34, to the outlet at closing/opening valve 25, by gravity, assisted by air pressure in the heating chamber by a valve 45 associated to an air inlet 43. Obviously, also in this case, the heating chamber may comprise more than one inlet for different components. Heating chamber 20 may be heated in a not shown way by means of an electrical resistance or by a gas-fired heater. Instead of positive pression, valve 45 can be provided at closing/opening valve 25 for carrying out a suction of the product.

The different exemplary embodiments of heating chamber 20, described in FIGS. 2, 3, 4, 5, obviously comprises means for controlling and adjusting the temperature to assist a correct heating of the components and a correct operation of the apparatus.

FIGS. 7-10 show a cross section of a possible shape of the edible container to be filled according to the present invention. In particular, they are thin-walled shells, for example with substantially cylindrical 100, or spherical 101, cubic 102 or conical 103 shape, respectively. The edible container can be made in other shapes not shown, also fancy or irregular or flatter shapes, having an opening for filling.

In FIG. 11 a cross section is shown of an end of a radial arm 62 of a carousel for bringing the edible container through different stations. End 62 has a hollow support 63, with multipurpose profile for supporting edible containers having different shapes. For example, support 63 has a recess with a spherical portion 111 and a conical portion 112, suitable for supporting either a conical 103 or spherical 101 edible container.

FIGS. 12-15 show a different solution of a multipurpose support for different shapes of an edible container. In particular, this solution is obtained using a releasable wrapper 140, for example of metal, paper or plastics, which bears the lower part of the edible container and has a flange 130, on which a support 110′ rests, and a recess, through which part of the support hangs downwards. In FIGS. 12-15 some examples of wrapper are shown and, in particular a wrapper 120 for container 100, a wrapper 121 for container 101, a wrapper 122 for container 102, a wrapper 123 for conical container 103.

Figures from 16 to 18 show a diagrammatical view of a preferred exemplary embodiment of the apparatus according to the invention, respectively in three operative steps. The apparatus comprises a heating chamber 20 having a horizontal rotating heated disc 150, receiving from a distributor 154 a product to be heated, such as at least one chopped component 151, distributed on the upper surface of disc 150. In chamber 20 a radial fixed barrier 152 is provided, located in sliding contact with the upper surface of rotating disc 150. This barrier 152 is suitable for stopping and accumulating on it food component 151 distributed chopped on heated disc 150. The device comprises also a plate 153 movable along barrier 152, having an edge sliding on the barrier and an edge on the disc, suitable for pushing radially the accumulated component 151 towards an outlet 155 and then into an edible container 156.

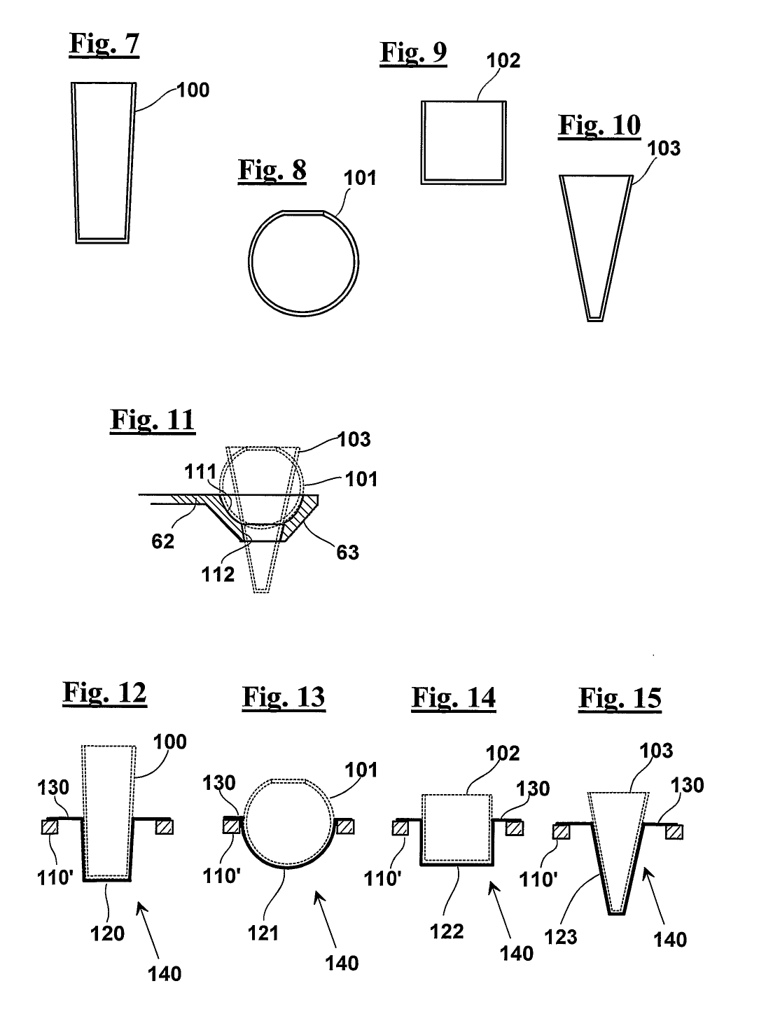

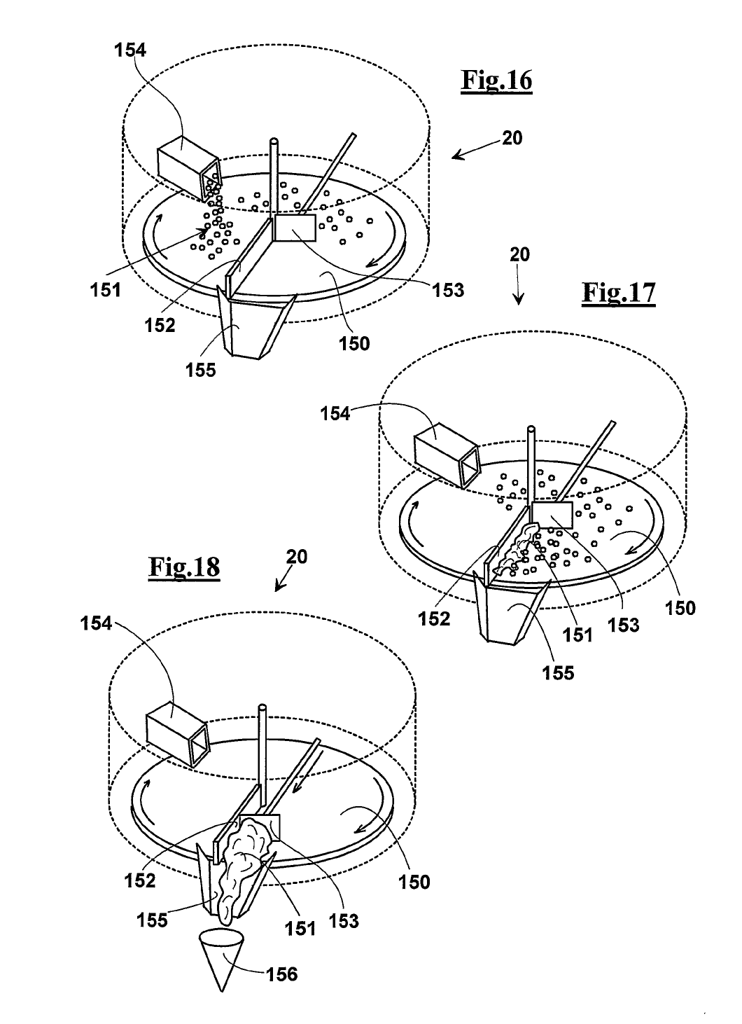

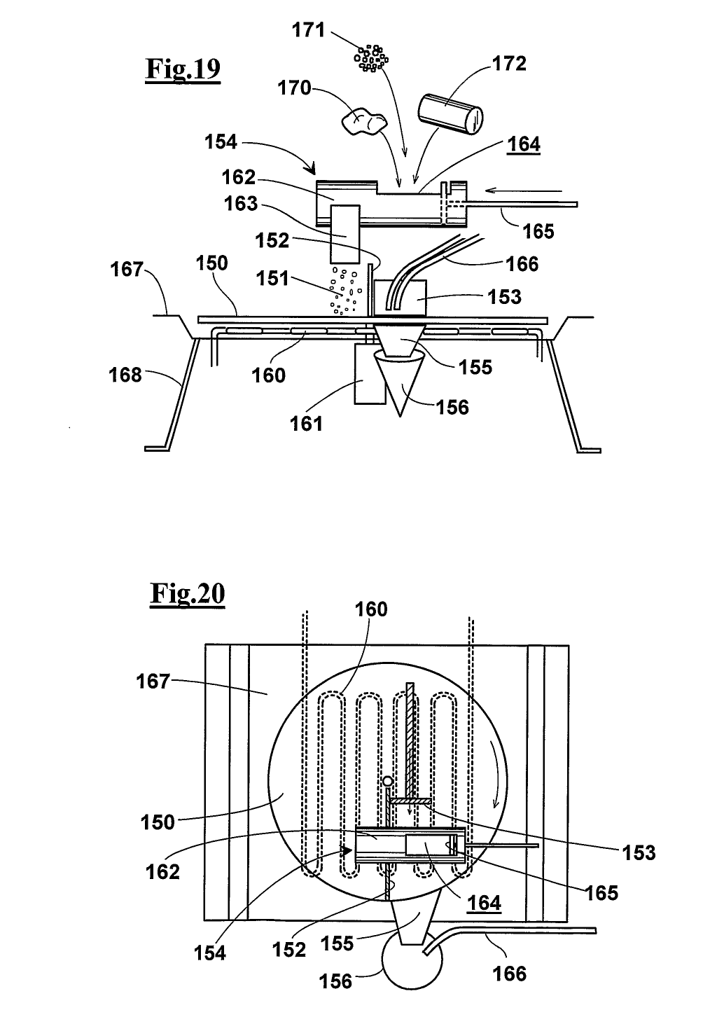

FIGS. 19 and 20 show in more detail respectively a front and a top plan view of the apparatus of FIGS. 16-18. Horizontal disc 150 is shown heated by electrical resistance 160 located underneath and wheeled about its axis by an electric motor 161. Plate 153 is movable along the barrier 152, with an edge sliding on barrier 152 and an edge along disc 150, pushing radially the heated component 151 towards outlet 155 and then into edible container 156. Food component 151 is distributed, and can be also chopped, by distributor 154 having a container 162, for example cylindrical with an inlet 164, an outlet 163 and a piston 165 for pushing the food component from opening 164 to outlet 163. Through this opening 164 at least one food component can be inserted, like a shredded cheese block 170, for example mozzarella, or an already chopped component 171, as well as one or more components contained in a cartridge 172, just opened and distributed on the disc 150 by distributor 154. In particular, cartridge 172 can be open automatically by distributor 154. The apparatus, furthermore, comprises ducts 166 suitable for inlet of at least one creamy or liquid food component, for example tomato sauce, for dressing the component 151 either immediately before or immediately after its release into the edible container.

The motion of the apparatus, i.e the motion of disc 150, of plate 153, or of distributor 154, etc., can be operated automatically by a control unit, for example a PLC, not shown in the figure.

In case the apparatus is supplied by a food component in a cartridge, its operation can be completely automatic, as a vending machine to be used in a station, an airport, an office, etc., capable of providing a warm single-dose food product, ready for being eaten, starting from food components just exiting from the cartridge, then with good freshness and well preserved, and combined with the edible container.

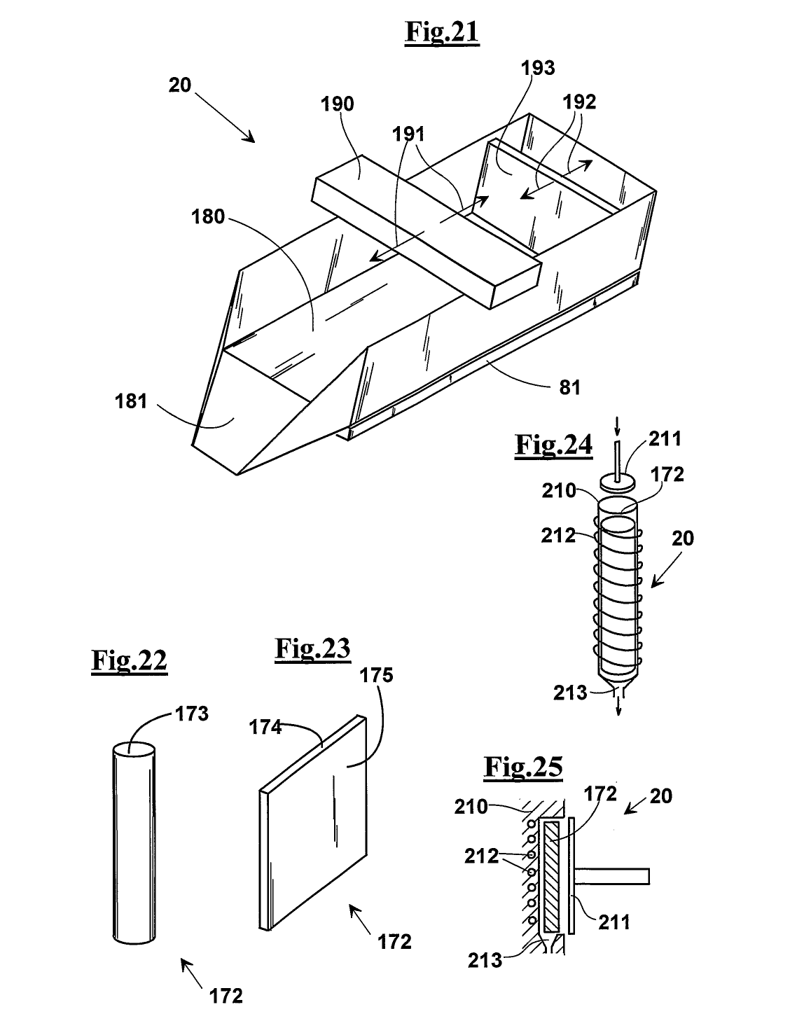

FIG. 21 shows diagrammatically an alternative exemplary embodiment of a heating chamber 20 comprising a releasable basin 180 operatively arranged on a heater 81, for example an electrical resistance, and a shovel 193 slidable longitudinally in said basin in order to push towards an outlet 181 the warm food heated in said basin. Heating chamber 20 has a distributor 190 diagrammatically shown in the figure, for at least one food component in it contained, capable of moving longitudinally above basin 180 according to arrows 191. This way, the component, for example mozzarella, is distributed regularly on the inner surface of said basin 180 so that it is heated quickly, before being pushed towards the outlet. Distributor 190 may comprise shredding means the food component before distributing it regularly on basin 180.

Alternatively, said distributor comprises a device not shown for opening automatically a food component in a cartridge and distributing it on the surface of said basin 180.

FIGS. 22 and 23 show respectively two possible exemplary embodiments of a component in a cartridge that can be opened and squeezed automatically and, in particular FIG. 22 shows a cylindrical cartridge with a portion that can be opened 173, whereas FIG. 23 shows a cartridge with substantially plane tray-like shape that may have a portion that can be opened on an edge 174 or on a face 175.

FIG. 24 shows a heating chamber 20 for a food component in a cartridge 172 with cylindrical shape, put in a recess 210 that encircles the cartridge, and has a piston 211 capable of compressing the cartridge and squeezing it to cause the component to exit through outlet 213, after heating by an electrical resistance 212 wound about recess 210.

Similarly, FIG. 19 shows another exemplary embodiment of a heating chamber 20 for use with a tray-like flat cartridge 172, comprising a recess 210 and a piston 211, which compresses cartridge 172, and squeezes it to cause the component to exit through the outlet, after heating by electrical resistance 212.

In an exemplary embodiment not shown in the figure, the food component in a cartridge can be heated either before or after opening the cartridge and then squeezed into the edible container.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. An apparatus for supplying a dose of warm food product, characterised in that it comprises means for receiving at least one component of said dose, heating it and putting it, once heated, into a stiff edible container, creating a ready to eat combination of said at least one food warm food component and of said edible container.

2. An apparatus, according to claim 1, wherein said means for receiving at least one component of said dose, heating it and putting it, once heated, into an edible container, comprises:
an inlet for at least one component of said food product;
at least one heating chamber with means for heating said or each component put in through said inlet;
means for moving towards an outlet said or each component after heating in said chamber and for creating said dose directly in said edible container.

3. An apparatus, according to claim 1, wherein said means for heating said at least one component provide a preheated surface with which said component comes into contact.

4. An apparatus, according to claim 3, wherein said preheated surface is a base surface of a shaped basin having an outlet for said heated component.

5. An apparatus, according to claim 3, wherein said preheated surface comprises a fixed heating plate.

6. An apparatus, according to claim 5, wherein said means for moving towards an outlet said or each component after heating comprises a piston coupled to said heating chamber, said piston being suitable for pushing said at least one component, stopped and accumulated on said surface, towards an outlet.

7. An apparatus, according to claim 2, wherein said heating chamber comprises an inner rotating horizontal heated disc, suitable for receiving and heating said at least one component, distributed on the upper surface of said disc.

8. An apparatus, according to claim 7, wherein said means for moving towards an outlet said or each component after heating comprises:
a fixed barrier that is radially arranged in sliding contact with said upper surface of said disc,
suitable for stopping and accumulating said at least one food component distributed chopped on said disc, once heated;
a pusher comprising a plate movable along said barrier, having an edge sliding on said barrier and an edge sliding on said disc, said pusher being suitable for pushing radially said at least one component, stopped and accumulated on said barrier, towards an outlet.

9. An apparatus, according to claim 4, 5 or 7, wherein said basin, said plate or said disc are removable for cleaning operations.

10. An apparatus, according to claim 3, wherein, for enhancing heat exchange between said surface and said component one of the following steps is provided:
shredding said component and distributing it on all said surface through shredding means;
dragging said component on said surface;
rolling said component on said surface.

11. An apparatus, according to claim 2, wherein said inlet is arranged in a refrigerating chamber, suitable for keeping at a preservation temperature said or each component before bringing it into said heating chamber.

12. An apparatus, according to claim 2, wherein said inlet is suitable for containing an edible component in blocks and is associated to means for shredding said edible component in blocks.

13. An apparatus, according to claim 10, wherein means are provided for bringing about a relative movement between said shredding means and said heating chamber, suitable for distributing said component regularly on the surface of said chamber.

14. An apparatus, according to claim 13, wherein said inlet is a hopper comprising a sensor for measuring the filling level thereof.

15. An apparatus, according to claim 2, wherein said heating chamber comprises means for mixing said or each component.

16. An apparatus, according to claim 15, wherein said means for mixing comprises an helical surface arranged in said heating chamber, with vertical axis and high angle of inclination of the helical surface, in order to have a high slope to assist the sliding of said or each component by gravity towards an outlet.

17. An apparatus, according to claim 16, wherein said helical surface has an inclined axis.

18. An apparatus, according to claim 1, wherein said at least one food component is kept in a single-dose cartridge or in a cartridge with a limited number of doses.

19. An apparatus, according to claim 18, wherein said cartridge is suitable for being put into said heating chamber for being then opened operatively to provide said at least one warm food component.

20. An apparatus, according to claim 18, wherein means are provided for opening automatically said portion of said cartridge selected from the group comprised of:
a recess containing operatively said cartridge and a piston suitable for compressing said cartridge by means of relative movement up to smashing said portion;
a recess containing operatively said cartridge and a cutting element capable of penetrating into said portion by means of relative movement.

21. An apparatus, according to claim 21, wherein said recess is said heating chamber.

22. An apparatus, according to claim 18, wherein said cartridge is obtained with a stiff or flexible material and has a shape selected from the group comprised of:
a cylinder;
a prism with two bases having size much larger than the height,
a closed tray with a surface that can be perforated;
a bag with substantially plane shape.

23. An apparatus, according to claim 2, wherein said heating chamber has a bottom with an opening and said means for moving towards an outlet provide means for having a overpression or depression in order to push said or each component towards said opening.

24. An apparatus, according to claim 2, wherein said heating chamber comprises a distributing device with automatic valve or timer or electronic operation.

25. An apparatus, according to claim 2, wherein said heating chamber comprises means for feeding at least one liquid substance in said chamber, said liquid substance assisting and completing the homogenization of said or each component.

26. An apparatus, according to claim 1, wherein said apparatus for supplying a dose of a warm food product comprises means for adding at least one food dressing component on top of said combination of said ready-to-eat single-dose warm food product and of said edible container.

27. An apparatus, according to claim 1, wherein said at least one food component is selected from the group comprised of:
cheese;
meat or delicatessen;
fresh or preserved vegetables;
pickled or in oil food;
fish.

28. An apparatus, according to claim 1, wherein said stiff edible container is a baked product with concave thin-walled shape and has a shape selected from the group comprised of:
a shell representing a geometrical figure, such as a spherical, cylindrical, conic, cubic, shell etc.;
a shell representing a fruit or a vegetal;
a shell that represents an animal, a character, a flower, etc.;
a shell that represents a common object.

29. An apparatus, according to claim 1, wherein means are provided for carrying said edible container under said means for moving, with at least one support element for said edible container, suitable for picking up and positioning said edible container at least at one operative station.

30. An apparatus, according to claim 29, wherein said means for carrying comprises a carousel support having a plurality of holding elements selectively moving through any of the following stations:
container pick up;
container heating;
container filling;
adding at least one food dressing component;
product delivery.

31. An apparatus, according to claim 1, wherein said apparatus is an automatic apparatus contained completely in a stiff casing, creating a vending machine suitable for delivering said combination of said ready-to-eat single-dose warm food product and of said edible container automatically according to a combination selected by a user.

32. An apparatus, according to claim 32, wherein said automatic apparatus comprises:
a refrigerated feeder for a plurality of cartridges suitable for being selectively picked up;
a heating chamber for a cartridge picked up from said feeder;
a feeder for a plurality of edible containers suitable for being selectively picked up;
means for opening said cartridge and bringing said ready-to-eat single-dose warm food product out from said cartridge into an edible container previously picked up.
